(19) United States
(12) Patent Application Publication
(10) Pub. No.: US 2015/0095141 A1
(43) Pub. Date: Apr. 2, 2015

(54) METHOD, APPARATUS, AND COMPUTER PROGRAM PRODUCT FOR FACILITATING MARKETING BETWEEN BUSINESSES

(71) Applicant: Advtravl, Inc., Ocala, FL (US)

(72) Inventors: Rahul Razdan, Ocala, FL (US); Fang Cao, Ocala, FL (US); ZhenBo Shi, Ocala, FL (US); Andrew Gianikas, Ocala, FL (US); Di Wang, Gainesville, FL (US)

(73) Assignee: Advtravl, Inc., Ocala, FL (US)

(21) Appl. No.: 14/041,106

(22) Filed: Sep. 30, 2013

(51) Int. Cl. G06Q 30/02

(52) U.S. Cl. CPC G06Q 30/0273; G06Q 30/0269; G06Q 30/0246; G06Q 30/0261
USPC 705/14.45; 705/14.69; 705/14.66; 705/14.58

(57) ABSTRACT

A method, apparatus and computer program product are provided for facilitating a marketing interlock between businesses. Two or more businesses may enter into a co-marketing campaign in which a sponsoring entity funds an advertisement of a sponsored entity on a third party advertising system, such as a search engine. Marketing content of the sponsoring entity is inserted on the website of the sponsored entity. Traffic originating on the third party advertising system may therefore first be driven to the sponsored entity's website, and subsequently to the sponsoring entity's website, thereby achieving a mutually beneficial co-marketing relationship. Marketing relationships among complimentary businesses based on provided service and location may also be facilitated according to the methods provided.

### FIELD

Various embodiments described herein are related to marketing of businesses on the Internet.

### BACKGROUND

Many businesses engage in marketing campaigns on the Internet. Businesses publish webpages, and third-party search engines crawl the Internet and connect users to businesses based on matching of search keywords to website content (e.g., organic search). Third-party search engines allow for the purchase of advertising in order to favor a particular website while presenting search results. Search engine providers are paid based on a number of impressions or selection of an impression (e.g., pay-per-click). Because there is no standard for the architecture of websites, a limited number of businesses engage in advertising directly on other business's websites. The vast number of businesses having Internet presence creates an opportunity for expanded marketing relationships between businesses.

### BRIEF SUMMARY

A method, apparatus, and computer program product are therefore provided for facilitating a marketing interlock between businesses on the Internet. As described herein, embodiments of the claims provide mutually beneficial co-marketing opportunities to businesses.

A method for facilitating marketing of at least two entities is provided, the method comprising receiving, from a sponsoring entity, a funding indication indicating an intent to fund a third party advertisement of a sponsored entity, receiving, from the sponsored entity, a marketing indication indicating an intent to place marketing content of the sponsoring entity on a website associated with the sponsored entity in exchange for the sponsoring entity funding the third party advertisement of the sponsored entity, and with a processor, and in response to the funding indication and marketing indication, causing marketing content of the sponsoring entity to be displayed on the website associated with the sponsored entity.

The method may include, providing to the sponsoring entity a plurality of entities within a predefined geographic proximity, wherein receiving the funding indication comprises receiving a selection of at least one of the plurality of entities as the sponsored entity. In some embodiments, the method includes, based on the funding indication, transmitting a request to the sponsored entity expressing the intent of the sponsoring entity to fund the third party advertisement of the sponsored entity.

In some embodiments, the third party advertisement of the sponsored entity may comprise a link to the website associated with the sponsored entity. The third party advertisement of the sponsored entity may be provided via a web-based search engine. In some embodiments, the marketing content of the sponsoring entity on the website associated with the sponsored entity comprises a link to a website associated with the sponsoring entity.

Receiving the marketing indication may include receiving an indication of an agreement between the sponsored entity and a marketing facilitator to reserve marketing content space on the website associated with the sponsored entity, wherein the agreement is made prior to receiving the funding indication, and the method further comprises maintaining the marketing content space on the website associated with the sponsored entity. The method may further include causing transmittal of a notification to a provider of the third party advertisement to provide the third party advertisement of the sponsored entity.

The sponsored entity may not initially be registered with a marketing facilitator and the funding indication comprises information identifying the sponsored entity, and the method further comprises, in response to the funding indication, causing transmittal, to the sponsored entity, of an invitation to register with the marketing facilitator. In some embodiments, the method further includes receiving a request from the sponsored entity to block marketing content of a particular entity from being placed on the website associated with the sponsored entity. The method may include receiving a recommendation from the sponsored entity to recommend a recommended business, and in response to the recommendation, causing display of marketing content of the recommended business on the website associated with the sponsored entity. The method may further include causing display of analytics data including at least one of a number of impressions or number of clicks of the third party advertisement of the sponsored entity occurring within a defined period of time.

A computer program product for facilitating marketing of at least two entities is also provided, the computer program product comprising at least one non-transitory computer-readable medium having computer-readable program instructions stored therein, the computer-readable program instructions comprising instructions, which, when performed by an apparatus, are configured to cause the apparatus to at least receive, from a sponsoring entity, a funding indication indicating an intent to fund a third party advertisement of a sponsored entity, receive, from the sponsored entity, a marketing indication indicating an intent to place marketing content of the sponsoring entity on a website associated with the sponsored entity in exchange for the sponsoring entity funding the third party advertisement of the sponsored entity, and in response to the funding indication and marketing indication, cause the marketing content of the sponsoring entity to be displayed on the website associated with the sponsored entity.

Another method is provided for facilitating business marketing relationships, the method comprising identifying a service category and a defined geographic area of a subject business entity, identifying at least one related service category to the subject category of the subject business entity, identifying at least one related business entity belonging to the at least one related service category and located in the defined geographic area, and establishing a marketing relationship between the subject business entity and the at least one related business entity in a business entity database.

Additional features and advantages of the present invention will be set forth in portion in the description which follows, and in portion will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention as claimed.

### BRIEF DESCRIPTION OF THE SEVERAL VIEWS OF THE DRAWINGS

FIG. 1 shows an example system in accordance with some example embodiments discussed herein;

FIG. 2 shows a schematic block diagram of a marketing facilitation system in accordance with some example embodiments discussed herein;

FIGS. 3-8 are example displays provided by a marketing facilitation system in accordance with some example embodiments discussed herein;

FIG. 9 is a flowchart illustrating operations for facilitating a marketing interlock between businesses in accordance with some example embodiments discussed herein;

FIG. 10 is a flowchart illustrating operations for facilitating business marketing relationships in accordance with some example embodiments discussed herein;

FIG. 11 is a flowchart illustrating operations for recommending businesses in accordance with some example embodiments discussed herein; and

FIG. 12 is a conceptual model illustrating related service categories in accordance with some example embodiments discussed herein.

### DETAILED DESCRIPTION

Embodiments of the present invention now will be described more fully hereinafter with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

As used herein, the terms “data,” “content,” “information” and similar terms may be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the other computing device or may be received indirectly via one or more intermediary computing devices, such as, for example, one or more servers, relays, routers, network access points, base stations, and/or the like. Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, and/or the like.

The methods, systems and apparatuses described herein may enable a marketing facilitation system (e.g., a system that provides marketing opportunities to businesses and promotes co-marketing relationships among businesses and is maintained by a marketing facilitator) to provide a marketing interlock to benefit at least two entities.

In this regard, a sponsoring entity, such as a business or other entity may provide funding for a third party advertisement of another business (the sponsored entity). In return, the sponsored entity, which may be a business or other entity, may place marketing content of the sponsoring entity on a website of the sponsored entity. The marketing interlock and co-marketing campaign may therefore result in increased exposure for both the sponsoring entity and sponsored entity.

For example, a tourist planning a weekend getaway to explore North Carolina wineries may utilize an Internet search engine. The tourist may see a list of North Carolina wineries returned as search results and/or targeted ads, and visit one or more of the sites. One winery in particular may look interesting to the tourist, and while exploring the winery's website, the tourist notices marketing content for a nearby hotel. The tourist clicks the hotel marketing content, and makes a reservation for his visit. The hotel may therefore benefit from the marketing content on the website of the winery by driving internet traffic first to the winery website and then subsequently to the hotel website. Given that the hotel may have a larger marketing budget than that of the winery, the hotel may find it beneficial for the hotel to choose to fund marketing on behalf of the winery, thereby benefitting the winery and helping to drive more Internet traffic to the hotel website. Further, it may be possible that the cost to place marketing content for the winery on the search engine result page may be less than the cost to place marketing content for the hotel.

In this regard, a sponsoring entity, such as the hotel, may provide a funding indication to a marketing facilitator, showing intent to fund marketing, such as with a search engine, on behalf of a sponsored entity (such as the winery). The sponsored entity may accept the sponsorship by providing a marketing indication to the marketing facilitator, showing intent to allow the sponsoring entity to place marketing content on its website.

The marketing interlock may therefore enable a co-marketing campaign for small business and/or groups of small businesses (e.g., the sponsored entity) and a larger business (e.g., the sponsoring entity). The sponsoring entity may engage in such co-marketing campaigns to integrate the marketing effort between its own core business offering and large sets of complementary small businesses by inserting marketing content on websites of the small businesses, such as in a partners section of the small business website. In addition, the sponsoring entity may provide funds to the small businesses for the purpose of buying advertising for their websites with the search engines.

A marketing interlock between businesses may additionally allow the sponsored entity to be advertised by third party search engines in scenarios in which the sponsored entity may otherwise not be able to advertise because the sponsored entity is not engaged in the same business as the sponsoring entity, for example. The injection of marketing content may be controlled explicitly by the sponsoring entity and may thus be customized to align with the business of the sponsored business.

The marketing interlock and co-marketing campaign may be implemented by defining a website architecture for business websites within a marketing facilitation system. The website architecture may include core details of the business and/or the functions of a traditional website. The website architecture may additionally include an area reserved for display of marketing content (e.g., an advertisement, image, text, and/or link) associated with another business entity or complementary businesses (e.g., businesses having related services or similar customer base, for example). In some embodiments, the website architecture may designate an area for display of marketing content of sponsoring entities, such as a large business having an interest in the success of the sponsored entity. In some embodiments, this architecture may be fixed and may provide the core building block for enabling business to engage in co-marketing campaigns.

Recommendations of businesses may be made, promoting the development and expansion of marketing networks based on crowd sourcing. A marketing facilitation system may facilitate these recommendations, and maintain the marketing content areas of various business websites based on the relationships between businesses and provided website architecture.

In this regard, as discussed in greater detail below, the methods, systems, and computer program products discussed herein provide an opportunity for increased internet exposure of both sponsoring entities and sponsored entities engaged in a marketing interlock campaign.

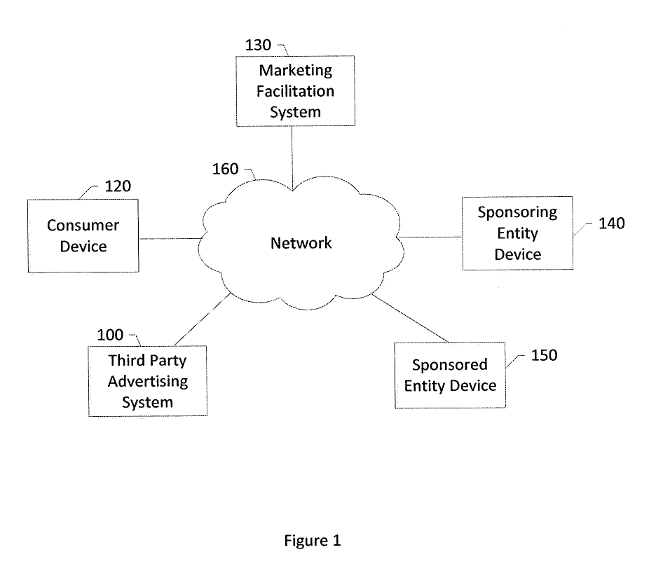

FIG. 1 shows an example system in accordance with some example embodiments discussed herein. The system may comprise a third party advertising system 100, consumer device 120, marketing facilitation system 130, sponsoring entity device 140, and sponsored entity device 150, configured to communicate over a network 160.

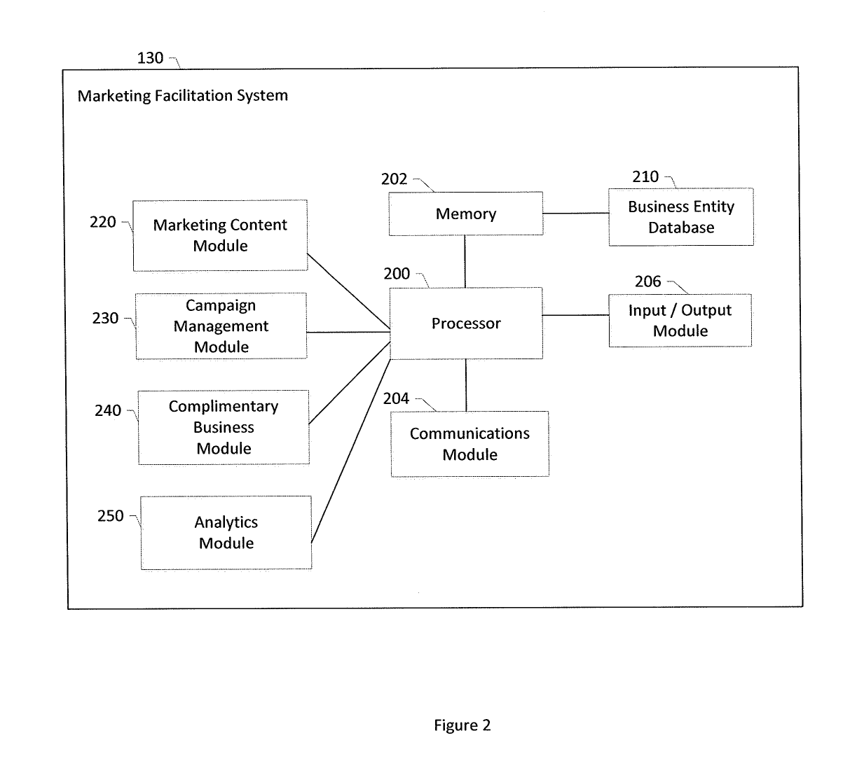

Third party advertising system 100 may be any system, server, device, or the like, configured to provide ads to internet users on behalf of another party. In this regard, the third party advertising system 100 may be configured to receive direction from the marketing facilitation system 130 (described in further detail with respect to FIG. 2) to provide ads of sponsored entities, such as via a web-based interface to a search engine. The ads may be targeted ads configured to be displayed to users of the third party advertising system 100 based on particular keywords (e.g., “North Carolina” and “winery”). Third party advertising system 100 may therefore be implemented as or may be otherwise configured to communicate with a search engine providing targeted ads.

Consumer device 120 may be implemented as a personal computer and/or other networked device, such as a cellular phone, tablet computer, mobile device, etc., that may be used to view ads provided by the third party advertising system 100. Referring to the example described above, a consumer (e.g., the tourist) may use consumer device 120 to access a search engine to search by keyword. Third party advertising system 100 may provide advertisements based on the keyword search, such as ads for various wineries. The user of the consumer device 120 may therefore navigate to sites returned by the third party advertising system 100.

Sponsoring entity device 140 may be any device configured for use by a user affiliated with a sponsoring entity, and may be implemented as a personal computer and/or other networked device, such as a cellular phone, tablet computer, mobile device, etc., that may be used to access the marketing facilitation system 130 to engage in marketing relationships and/or utilize other services provided by the marketing facilitation system 130. In some embodiments, information, such as a funding indication, may be transmitted from sponsoring entity device 140 to the marketing facilitation system 130 to initiate marketing campaigns and/or enter into marketing relationships, such as a marketing interlock, with other businesses such as the sponsored entity. Continuing with the above example, a user affiliated with the hotel may use a sponsoring entity device 140 to access the marketing facilitation system 130 and provide a funding indication naming the winery as the sponsored entity.

Similarly, sponsored entity device 150 may be any device configured for use by a user affiliated with a sponsored entity, and may be implemented as a personal computer and/or other networked device, such as a cellular phone, tablet computer, mobile device, etc., that may be used to access the marketing facilitation system 130 to engage in marketing relationships and/or utilize other services provided by the marketing facilitation system 130. In some embodiments, information, such as a marketing indication, may be transmitted from sponsored entity device 150 to the marketing facilitation system 130, to initiate advertising campaigns and/or enter into marketing relationships with other businesses, for example. Referring again to the winery example, a user affiliated with the winery may therefore use a sponsored entity device 150 to accept a sponsorship by the hotel, and/or confirm insertion of the hotel's marketing content on the winery's website, thereby providing a marketing indication, indicating that the winery will agree to enter into a marketing interlock with the hotel.

Any number of third party advertising systems 100, consumer devices 120, sponsoring entity devices 140, and/or sponsored entity devices 150 may be present, and may be configured to communicate with each other or the marketing facilitation system 130 via network 160. In this regard, network 160 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, network 160 may include a cellular telephone, an 802.11, 802.16, 802.20, and/or WiMax network. Further, the network 160 may include a public network, such as the Internet, a private network, such as an intranet, or combinations thereof, and may utilize a variety of networking protocols now available or later developed including, such as, but not limited to, TCP/IP based networking protocols.

FIG. 2 shows a schematic block diagram of marketing facilitation system 130. In accordance with some example embodiments, marketing facilitation system 130 may include various means, such as one or more processors 200, memories 202, communications modules 204, and/or input/output modules 206. In some embodiments, the marketing content module 220, campaign module 230, complimentary business module 240, and/or analytics module 250 may be included. As referred to herein, the term “module” includes hardware, software and/or firmware configured to perform one or more particular functions. In this regard, marketing facilitation system 130 as described herein may be embodied as, for example, circuitry, hardware elements (e.g., a suitably programmed processor, combinational logic circuit, and/or the like), a computer program product comprising computer-readable program instructions stored on a non-transitory computer-readable medium (e.g., memory 202) that is executable by a suitably configured processing device (e.g., processor 200), or some combination thereof.

Processor 200 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments, processor 200 comprises a plurality of processors. The plurality of processors may be embodied on a single computing device or may be distributed across a plurality of computing devices collectively configured to function as marketing facilitation system 130. The plurality of processors may be in operative communication with each other and may be collectively configured to perform one or more functionalities of marketing facilitation system 130 as described herein. In an example embodiment, processor 200 is configured to execute instructions stored in memory 202 or otherwise accessible to processor 200. These instructions, when executed by processor 200, may cause marketing facilitation system 130 to perform one or more of the functionalities of marketing facilitation system 130 as described herein.

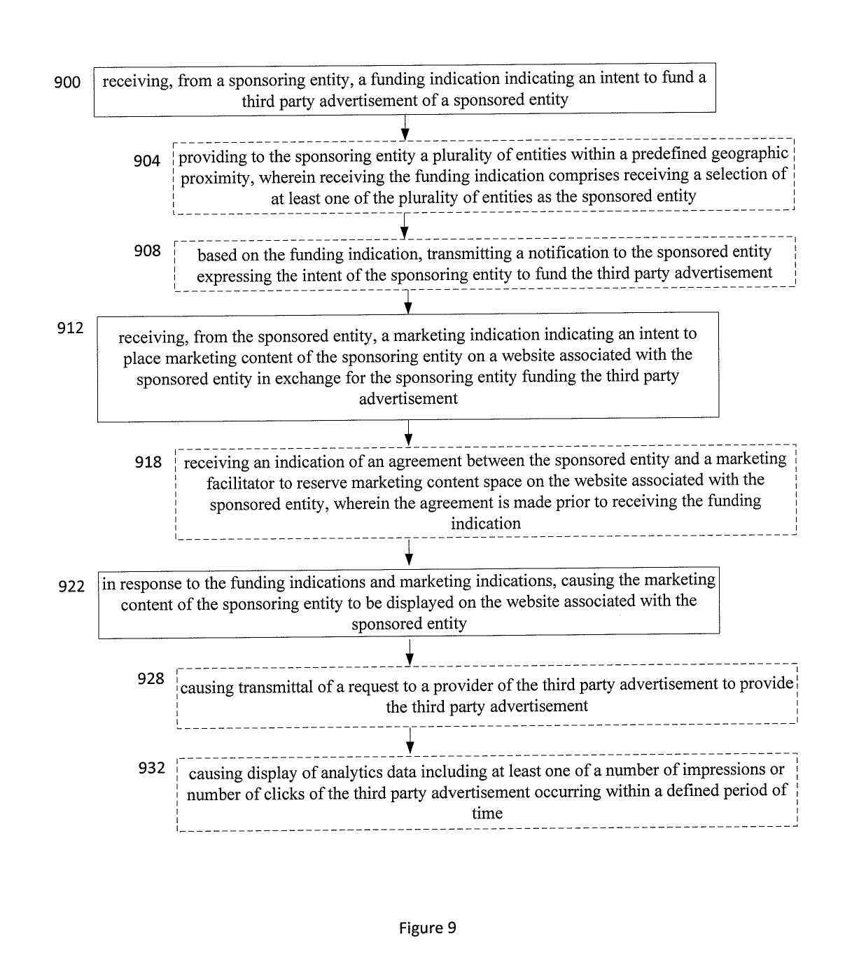

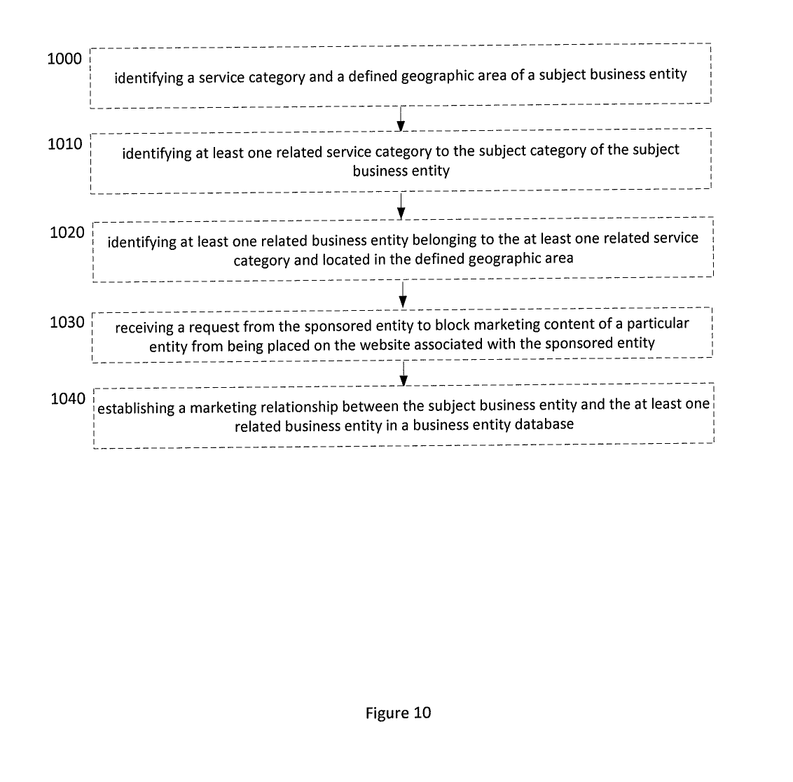

Whether configured by hardware, firmware/software methods, or by a combination thereof, processor 200 may comprise an entity capable of performing operations according to embodiments of the present invention while configured accordingly. Thus, for example, when processor 200 is embodied as an ASIC, FPGA or the like, processor 200 may comprise specifically configured hardware for conducting one or more operations described herein. As another example, when processor 200 is embodied as an executor of instructions, such as may be stored in memory 202, the instructions may specifically configure processor 200 to perform one or more operations described herein, such as those discussed in connection with FIGS. 9 and 10.

Memory 202 may comprise, for example, volatile memory, non-volatile memory, or some combination thereof. Although illustrated in FIG. 2 as a single memory, memory 202 may comprise a plurality of memory components. The plurality of memory components may be embodied on a single computing device or distributed across a plurality of computing devices. In various embodiments, memory 202 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In some embodiments, memory 202 may be configured to retrieve data from, or otherwise comprise business entity database 210. Memory 202 may be configured to store information, data (including business entity profiles, co-marketing campaign information, and/or analytics data), applications, instructions, or the like for enabling marketing facilitation system 130 to carry out various functions in accordance with example embodiments of the present invention. For example, in at least some embodiments, memory 202 is configured to buffer input data for processing by processor 200. Additionally or alternatively, memory 202 may be configured to store program instructions for execution by processor 200. Memory 202 may store information in the form of static and/or dynamic information. This stored information may be stored and/or used by marketing facilitation system 130 during the course of performing its functionalities.

Business entity database 210 may be any suitable network database configured to store data regarding business entities or the like, that may sponsor and/or be sponsored by another entity in a co-marketing campaign, such as a marketing interlock discussed herein, or that may otherwise be considered a potential sponsored or sponsoring entity. Business entity data stored in business entity database 210 may be associated with businesses registered with the marketing facilitation system 130, and/or not registered with the marketing facilitation system 130 (in which case the business entities may be identified as candidate users of the marketing facilitation system 130). In some embodiments, business entity data may be received from the business entity database 210 by entry of a business profile and/or received from a third party information source, or any other source.

Communications module 204 may be embodied as any device or means embodied in circuitry, hardware, a computer program product comprising computer readable program instructions stored on a computer readable medium (e.g., memory 202) and executed by a processing device (e.g., processor 200), or a combination thereof that is configured to receive and/or transmit data from/to another device, such as, for example, a second marketing facilitation system 130 and/or the like. The communications module 204 may be configured to receive funding indications from sponsoring entity device 140 and/or marketing indications from sponsored entity device 150. Additionally or alternatively, the communications module 204 may be configured to transmit data regarding advertisements for the sponsored entity to third party advertising system 100. In some embodiments, communications module 204 (like other components discussed herein) can be at least partially embodied as or otherwise controlled by processor 200. In this regard, communications module 204 may be in communication with processor 200, such as via a bus. Communications module 204 may include, for example, an antenna, a transmitter, a receiver, a transceiver, network interface card and/or supporting hardware and/or firmware/software for enabling communications with another computing device. Communications module 204 may be configured to receive and/or transmit any data that may be stored by memory 202 using any protocol that may be used for communications between computing devices. Communications module 204 may additionally or alternatively be in communication with the memory 202, input/output module 206 and/or any other component of marketing facilitation system 130, such as via a bus.

Input/output module 206 may be in communication with processor 200 to receive an indication of a user input and/or to provide an audible, visual, mechanical, or other output to a user (e.g., a user affiliated with a sponsoring entity or sponsored entity). As such, input/output module 206 may include support, for example, for a keyboard, a mouse, a joystick, a display, a touch screen display, a microphone, a speaker, a RFID reader, barcode reader, biometric scanner, and/or other input/output mechanisms. In embodiments wherein marketing facilitation system 130 is embodied as a server or database, aspects of input/output module 206 may be reduced as compared to embodiments where marketing facilitation system 130 is implemented as an end-user machine (e.g., consumer device 120, sponsoring entity device 140, and/or sponsored entity device 150) or other type of device designed for complex user interactions. In some embodiments (like other components discussed herein), input/output module 206 may even be eliminated from marketing facilitation system 130 during normal operation. Alternatively, such as in embodiments wherein marketing facilitation system 130 is embodied as a server or database, at least some aspects of input/output module 206 may be embodied on an apparatus used by a user that is in communication with marketing facilitation system 130, such as for example, sponsoring entity device 140, and/or sponsored entity device 150. Input/output module 206 may be in communication with the memory 202, communications module 204, and/or any other component(s), such as via a bus. Although more than one input/output module and/or other component can be included in marketing facilitation system 130, only one is shown in FIG. 2 to avoid overcomplicating the drawing (like the other components discussed herein).

The marketing content module 220 may provide functionality related to advertising of a sponsored entity on a third party advertising system and/or of a sponsoring entity on a sponsored entity's website, for example. In some embodiments, some or all of the advertising functionality may be performed by processor 200. In this regard, the example processes discussed herein can be performed by at least one processor 200 and/or marketing content module 220.

The campaign management module 230 may provide functionality related to facilitating co-marketing campaigns such as a marketing interlock between a sponsoring entity and a sponsored entity, in which advertising of the sponsored entity is funded by a sponsoring entity, as described herein. In some embodiments, some or all of the campaign management functionality may be performed by processor 200. In this regard, the example processes discussed herein can be performed by at least one processor 200 and/or campaign management module 230.

The complimentary business module 240 may provide functionality related to identifying and maintaining related service categories, identifying related business entities and/or making recommendations of businesses for the purposes of establishing marketing relationships between businesses. In some embodiments, some or all of the complimentary business functionality may be performed by processor 200. In this regard, the example processes discussed herein can be performed by at least one processor 200 and/or complimentary business module 240.

The analytics model 250 may provide functionality related to receiving analytics data from, for example, the third party advertising system 100, sponsored entity and/or sponsoring entity and presenting analytics data to the sponsoring entity. In some embodiments, some or all of the analytics functionality may be performed by processor 200. In this regard, the example processes discussed herein can be performed by at least one processor 200 and/or analytics model 250.

Non-transitory computer readable storage media can be configured to store firmware, one or more application programs, and/or other software, which include instructions and other computer-readable program code portions that can be executed to control each processor (e.g., processor 200, marketing content module 220, campaign management module 230, complimentary business module 240, and/or analytics model 250) of the marketing facilitation system 130 to implement various operations, including the examples described herein. As such, a series of computer-readable program code portions are embodied in one or more computer program products and can be used, with a computing device, server, and/or other programmable apparatus, to produce machine-implemented processes.

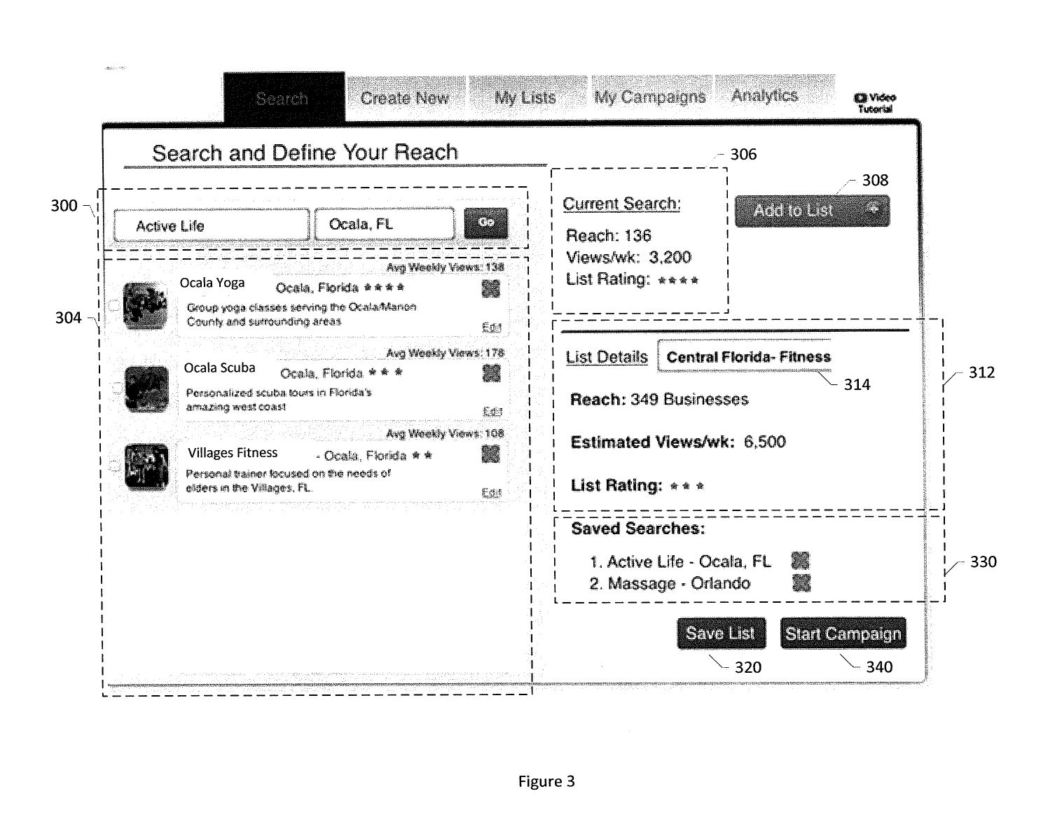

FIGS. 3-8 are example displays that may be provided by the marketing facilitation system 130, such as by communications module 204, input/out module 206, and accessed by a user of a sponsoring entity device 140, for example. In some embodiments, a user of the sponsoring entity device 140 may log onto the marketing facilitation system 130 to access displays such as those provided in FIGS. 3-8. In this regard, credentials, stored in memory 202 and/or business entity database 210, for example, may be verified by processor 200, or the like. In some embodiments, a user may access displays provided by marketing facilitation system 130 without logging onto the marketing facilitation system 130.

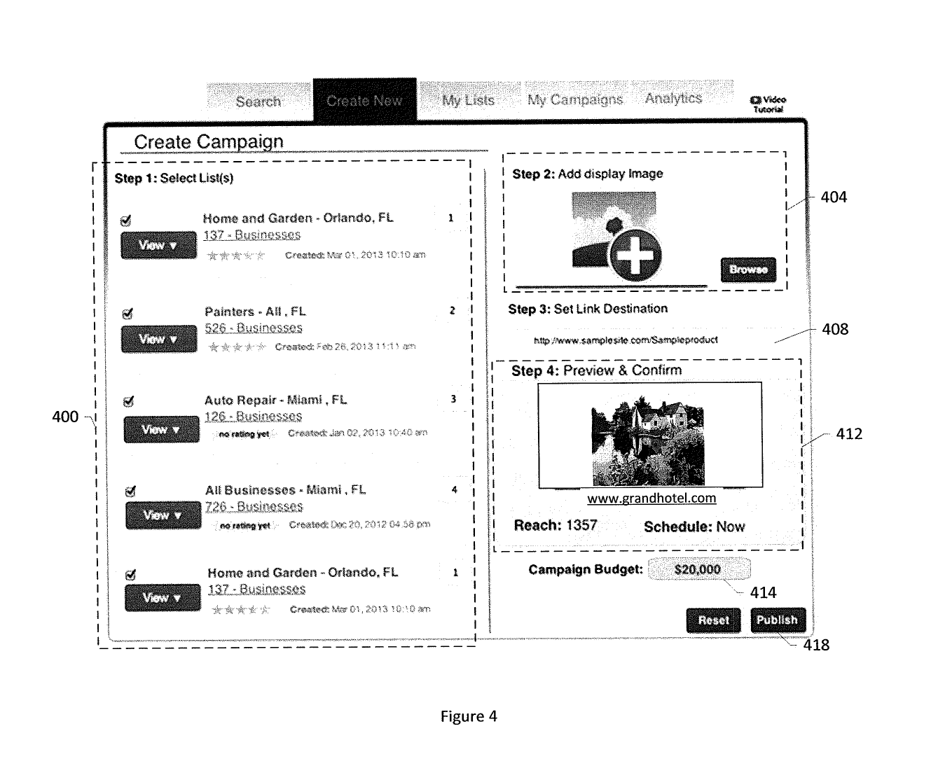

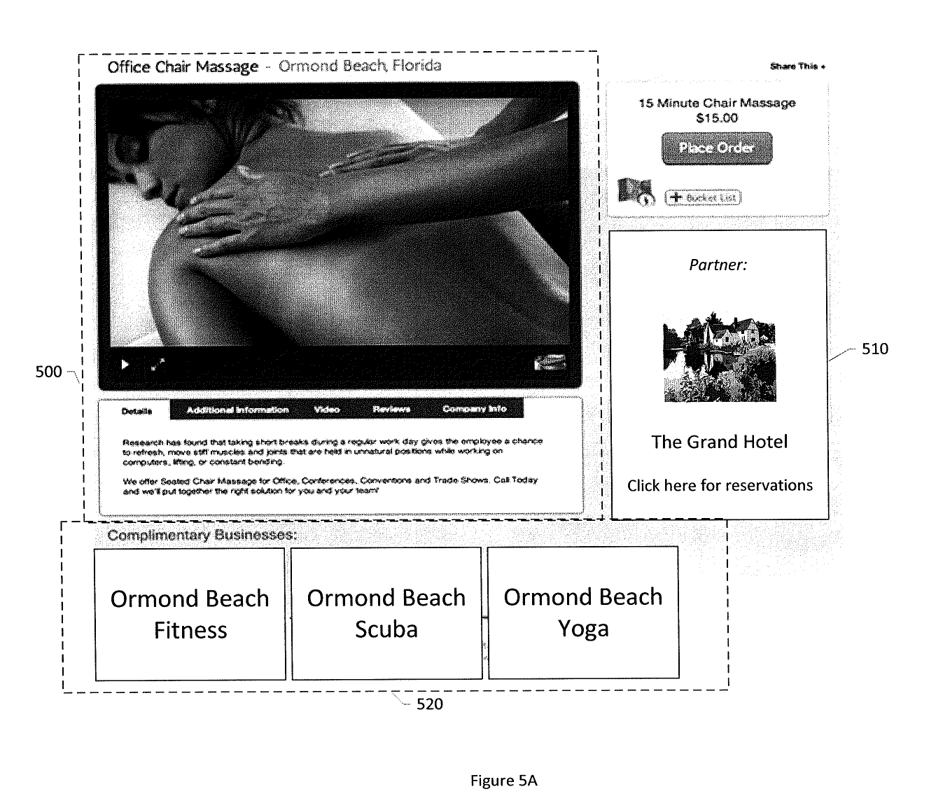

FIG. 3 is an example display that may be used by a user affiliated with a sponsoring entity (such as via a sponsoring entity device 140) to search for businesses to sponsor. In area 300, a user may provide search criteria for a business entity by keyword and/or location, for example. The marketing facilitation system 130 may therefore search the business entity database 210 for businesses matching the search criteria, and display the results in area 304. As shown, the search results in area 304 may include a business name, website link, location, user rating, brief description, and/or an average number of weekly views, such as provided by the third party advertising system 100 and/or marketing facilitation system 130. Area 306 may reflect cumulative totals for the businesses represented in the search results, such as businesses reached, total views per week, and an average rating. Suppression of a checkbox next to a business in area 304 and the selection of the “add to list” button 308, may result in adding the business to a list. The sponsoring entity may therefore customize a list of businesses it wishes to sponsor in a co-marketing campaign, such as with marketing interlocks with one or more of the listed businesses to be sponsored entities in the marketing interlock. As businesses are added to a list, area 312 may be updated to reflect a total number of businesses, estimated total number of views per week, and/or an average rating of businesses in the list. A user may also name a list with input 314, and/or save a list with button 320. Area 330 may display lists created by the sponsoring entity, which may accessed, edited, and/or deleted. Selection of button 340 may allow a user to transition to a display for starting a new campaign, such as the display of FIG. 4.

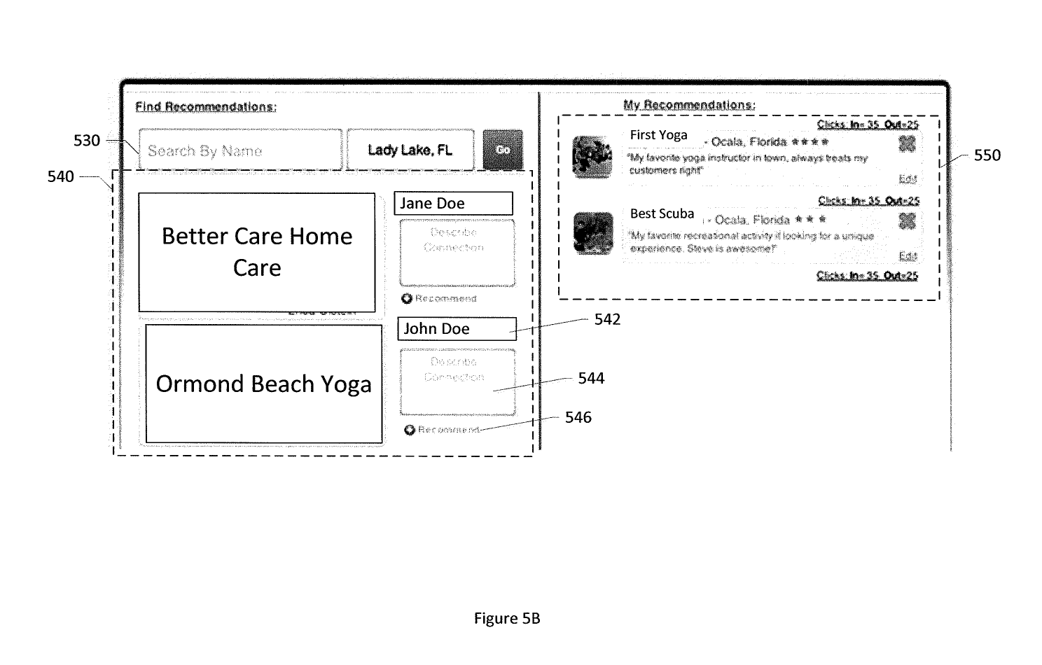

FIG. 4 is an example display that may be used by a user of a sponsoring entity device 140, for example, to initiate a co-marketing campaign. In area 400, a user may select a list(s), such as one created as described with respect to FIG. 3 above. List information such as the list title, number of businesses added to the list, average star rating (e.g., a star rating based on recommendations by other businesses), and creation timestamp may be provided. A number of active sponsored entities in the co-marketing campaign for the list may also be provided. Links to view and further configure a list may be provided, which may transition the display to another display such as that of FIG. 5. Area 404 provides an input for a sponsoring entity marketing content image, such as using the browsing functionality with which a user may select a local image for uploading to the marketing facilitation system 130 from the sponsoring entity device 140, for example, or to enter an address for a remote image. A destination link may be provided at input 408. The image provided in area 404 may therefore be provided on a website of a sponsored entity (e.g., a business selected in a list of area 400), and have an associated uniform resource locator (URL) to the website provided in area 408. An example of the marketing content comprising an image and URL provided in respective area 404 and input 408, is provided and described in further detail with respect to FIG. 5. Area 412 may include a preview of the marketing content to be displayed on the sponsored entity's website, and an option to schedule the campaign to start in the future. In some embodiments, the image and/or URL may be prefilled, such as in instances where the sponsoring entity has previously provided the image and/or URL for the purposes of another campaign, for example. A campaign budget may be provided at input 414 that may define the maximum dollars spent for ads of the sponsored entities on the third party advertising system 100. The budget may be for a predefined period of time or period of time determined by the user. Selection of the publish button 418 may result in publishing of the co-marketing campaign. Additionally or alternatively, a user may save a draft campaign for completion at a later time.

As a result of campaign publication, a number of events may be initiated. A funding indication may be transmitted to marketing facilitation system 130. The funding indication may indicate to the marketing facilitation system 130 the sponsoring entity's intent to sponsor any number of sponsored entities (as selected with respect to the displays of FIGS. 3 and 4) by paying for ads for the sponsored entities on a third party advertising system 100. The marketing facilitation system 130 may therefore communicate with the third party advertising system 100 to initiate the co-marketing campaign on behalf of the sponsored entities. Additionally or alternatively, the marketing facilitation system 130 may store the image and/or URL to memory 202, business entity database 210, or the like, to be used in placing the marketing content of the sponsoring entity on the sponsored entity's website, such as shown in FIG. 5.

In some embodiments, sponsored entities may be registered with the marketing facilitation system 130 such that any funding indications made by a sponsoring entity will result in a seamless integration of the sponsored entity's advertisement on the third party advertising system 100 and/or the sponsoring entity's marketing content on the sponsored entity's website. That is, a sponsored entity may provide a marketing indication (an indication of intent to place marketing content of the sponsoring entity in exchange for funding the third party advertisement) to the marketing facilitation system 130 in advance by registering on the marketing facilitation system 130. Additionally or alternatively, the sponsored entity may receive a request from the marketing facilitation system 130 notifying the sponsored entity of the funding indication. Regardless of implementation, FIG. 5A is an example display of a sponsored entity's website, comprising at least marketing content provided by marketing facilitation system 130.

Area 500 may encompass a portion of the sponsored entity's website which may be used to provide information to its customers. Area 510 may be reserved for marketing content of sponsoring entities, such as those funding a marketing interlock campaign, as provided by the marketing facilitation system 130. Area 510 may therefore include the image and/or URL provided by the sponsoring entity. A user who selects an marketing content in area 510 may then be redirected to the sponsoring entity's website. Area 520 may comprise ads of complementary businesses to that of the sponsored entity, which also may be provided by the marketing facilitation system 130. In some embodiments, the businesses having marketing content in area 520 may be identified by the sponsored entity as recommended businesses. FIG. 5B is an example display that may be used by small businesses, such as a sponsored entity, to recommend another business and drive a complementary business flow.

In area 530, a user may enter search criteria, and results may be provided in area 540. A user, such as a business user affiliated with a sponsored entity, may recommend one or more of the businesses. The business user may describe a connection to the business owner and/or contact 542 or a connection to the business by user input 544. The business user may then submit the recommendation to the marketing facilitation system 130 with indicator 542. Area 550 shows the recommendation made by various business users, and statistics regarding click ins and click outs. “Clicks in” is a count of users, such as clients or consumers, who have accessed the recommending business's website from the recommended business's website, and “clicks out” is a count of users who have accessed the recommended business's website from the recommending business's website. The statistics therefore help the business user gauge the impact of the recommendation to their own website. Based on the recommendations, the marketing facilitation system 130 may rank the recommended business higher and place a star on the website, such as shown in FIG. 5A. Additionally or alternatively, complimentary businesses may be self-identified by requests on the marketing facilitation system 130, and/or identified by the marketing facilitation system 130 (such as with complimentary business module 260) as having related services and/or products.

In some embodiments, the marketing facilitation system 130 may host a sponsored entity's website such as the example website of FIG. 5A. In some embodiments, the marketing facilitation system 130 may provide a script to a host of the website that may access the marketing facilitation system 130 for up to date campaign information for the sponsoring entities to be displayed in area 510 and/or complementary businesses to be displayed in 520. The marketing facilitation system 130 may generate such a script, such as with processor 200, marketing content module 220, or the like, upon receiving the marketing indication from the sponsored entity device 150. As such, a sponsored entity may advantageously configure a one-time setup of a script on its website. The sponsored entity may therefore uphold its commitment to the marketing interlock campaign without having to update ads on its website.

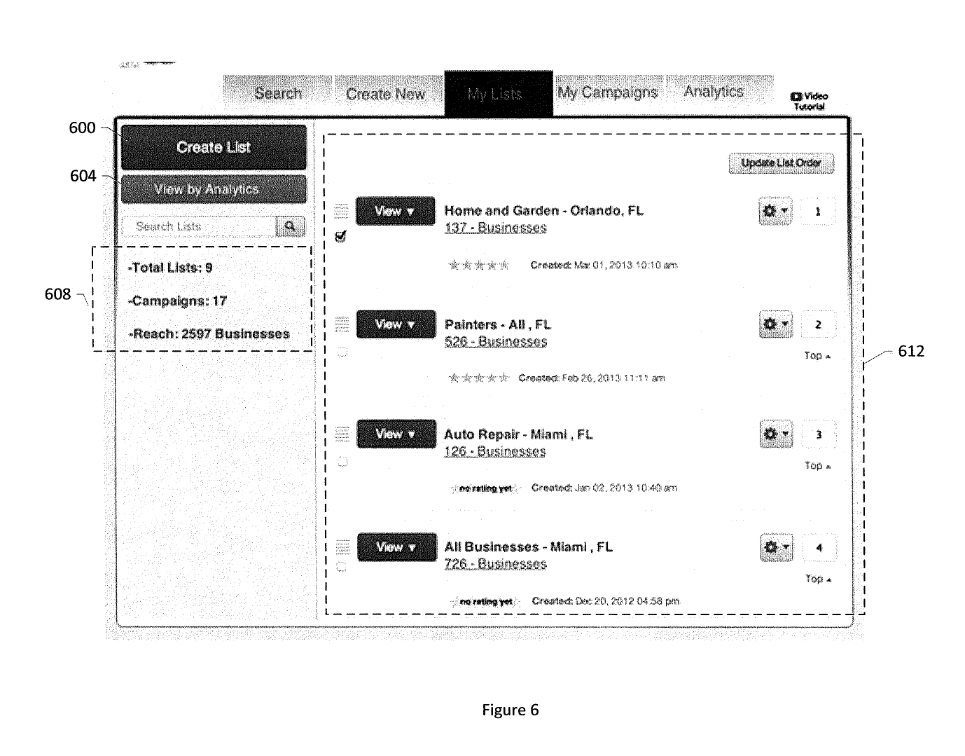

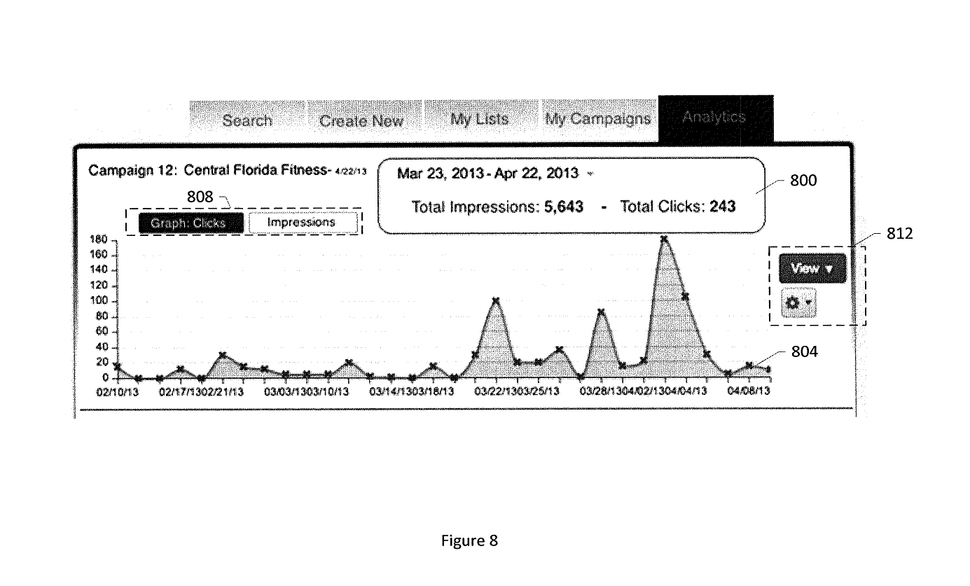

FIG. 6 is an example display that may be provided by marketing facilitation system 130 to allow a sponsoring entity to view and/or modify its lists of sponsored entities. The “create list” button 600 may allow a user to navigate to a display such as that of FIG. 3, to create a new list. The “view by analytics” button 604 may allow a user to navigate to a display such as that of FIG. 8, to view analytics. Area 608 may provide data to a user such as a total number of lists, total number of campaigns, and businesses or sponsored entities that the sponsoring entity sponsors with its campaigns. Area 612 may be provided by marketing facilitation system 130, such as with campaign management module 230, business entity database 210, and/or the like, to display the currently saved lists of sponsored entities saved and associated with the sponsoring entity. In some embodiments, a list may comprise sponsored entities engaged in a marketing interlock campaign. In some embodiments, the sponsored entities may be business entities identified as potential future businesses to sponsor.

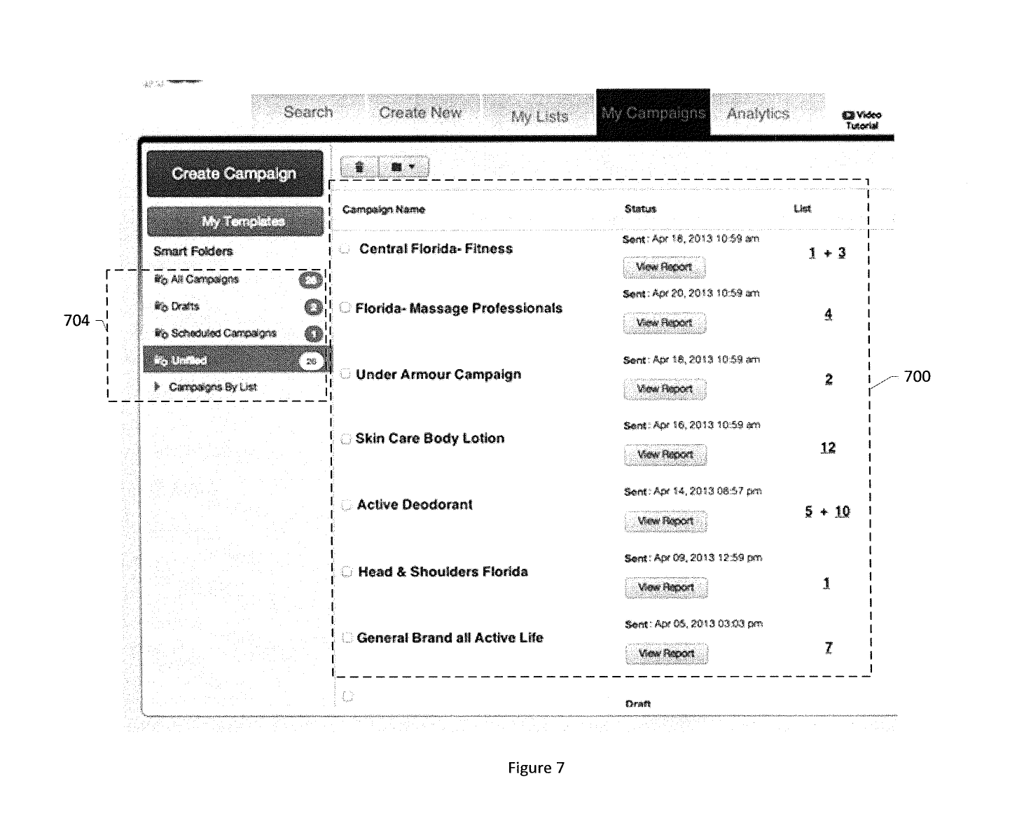

FIG. 7 is an example display that may be provided by marketing facilitation system 130, such as with campaign management module 230, or the like, for providing details regarding active and/or past campaigns. In this regard, campaign management module 230 or processor 200 may retrieve information from memory 202, business entity database 210, or the like, to display campaign names and associated status reports and the number of lists of sponsored entities (with corresponding links to the list view of FIG. 6), such as shown in area 700. Area 704 may be provided to allow a user to filter the campaigns displayed in area 700.

FIG. 8 is an example display that may be provided by marketing facilitation system 130, such as with analytics module 250, processor 200, communications module 204 or the like, for providing details regarding active and/or past campaigns. A sponsoring entity may therefore access an analytics display to determine the success of marketing interlock campaigns. The analytics data may be presented to a user by campaign and/or sponsored entity. As shown in area 800, the analytics module 250 may track impressions and/or clicks of the third party ads made on the third party advertising system 100. An impression may be considered any display of the targeted ad, while a click may be counted when a user selects the marketing content to navigate to the sponsored entity's website. In this regard, a sponsoring entity may view the analytics data to understand how much exposure the sponsoring entity is gaining by sponsoring a particular business. Additionally or alternatively, a graph of the data over time may be generated and displayed, such as graph 804. Indicators 808 may allow a user to toggle the graph to display impressions and/or clicks. Controls 812 may allow a user to navigate to other displays provided by the marketing facilitation system 130 to view and edit lists and/or campaigns.

FIG. 9 is a flowchart illustrating operations for facilitating a marketing interlock between businesses. The operations may be performed by the marketing facilitation system 130, for example, such as with any of the components of the marketing facilitation system 130 illustrated in FIG. 2 and described herein. Some of the operations, such as those bordered by a dashed line, may be optional.

As shown by operation 900, the marketing facilitation system 130, such as with the communications module 204, input/output module 206, processor 200, campaign management module 230, and/or the like, may be configured for receiving, from a sponsoring entity, a funding indication indicating an intent to fund a third party advertisement of a sponsored entity. As described above with respect to FIG. 4, a user affiliated with a sponsoring entity may use a display (such as the display of FIG. 4) to provide a funding indication, such as by selecting at least one sponsored entity, marketing content for the sponsoring entity, and/or a campaign budget, for example. Information relating to the funding indication, sponsoring entity, and/or sponsored entity may be stored on memory 202 and/or business entity database 210, for example.

As shown by operation 904, the marketing facilitation system 130, such as with the communications module 204, input/output module 206, processor 200, business entity database 210 and/or the like, may be configured for providing to the sponsoring entity a plurality of entities within a predefined geographic proximity, wherein receiving the funding indication may comprise receiving a selection of at least one of the plurality of entities as the sponsored entity. As described with respect to FIG. 3, a user affiliated with the sponsoring entity may use various searching techniques to identify entities to sponsor. One search criteria may include a particular city or metropolitan area, for example. The processor 200 may therefore identify businesses in the business entity database 210 as a candidate sponsored entity. The sponsoring entity may therefore select a sponsored entity in order to save the sponsored entity to a list and/or initiate a marketing interlock co-marketing campaign with the sponsored entity.

As shown by operation 908, the marketing facilitation system 130, such as with the communications module 204, input/output module 206, processor 200, campaign management module 230, and/or the like, may be configured for, based on the funding indication, transmitting a notification to the sponsored entity expressing the intent of the sponsoring entity to fund the third party advertisement. In some embodiments, the campaign management module 230 may direct the communications module 204 to notify the sponsored entity of a funding indication. This may be accomplished, for example, such as by sending a report and/or automated email to the sponsored entity. In some embodiments, the sponsored entity may not receive any notification, but the marketing content area of the sponsored entity's website may be configured to be updated by the marketing facilitation system 130 according to active campaign, providing a maintenance and/or hassle free option to the sponsored entity. In some embodiments, such as those in which the sponsored entity is not registered with the marketing facilitation system 130, the notification may comprise an invitation to register.

As shown by operation 912, the marketing facilitation system 130, such as with the communications module 204, input/output module 206, processor 200, marketing content module 220, and/or the like, may be configured for receiving, from the sponsored entity, a marketing indication indicating an intent to place marketing content of the sponsoring entity on a website associated with the sponsored entity in exchange for the sponsoring entity funding the third party advertisement.

As described herein, the marketing indication may be provided by the sponsored entity before the funding indication is received, such as via a registration process in which the sponsored entity agrees to enter into a marketing interlock or co-marketing campaign with any sponsoring entities, as facilitated by the marketing facilitation system 130. In some embodiments, the sponsored entity may not initially be registered with a marketing facilitator and the funding indication may include information identifying the sponsored entity. The marketing facilitation system 130, in response to the funding indication, may therefore cause transmittal, to the sponsored entity, of an invitation to register with the marketing facilitator. The sponsored entity may accept the invitation thereby providing a marketing indication to the marketing facilitation system 130 as an agreement to place marketing content of any sponsoring entities on its website.

As shown by operation 918, the marketing facilitation system 130, such as with the communications module 204, input/output module 206, processor 200, marketing content module 220, campaign management module 230, and/or the like, may be configured for receiving an indication of an agreement between the sponsored entity and a marketing facilitator to reserve marketing content space on the website associated with the sponsored entity, wherein the agreement is made prior to receiving the funding indication. As described above, the marketing facilitation system 130 may provide a business entity the option to register with the marketing facilitation system 130 to become a sponsored entity. The marketing facilitation system 130, such as with the campaign management module 230 and/or marketing content module 220 may therefore maintain the marketing content space on the sponsored entity's website.

As shown by operation 922, the marketing facilitation system 130, such as with the communications module 204, input/output module 206, processor 200, marketing content module 220, and/or the like, may be configured for, in response to the funding indication and marketing indication, causing a placement of marketing content of the sponsoring entity to be displayed on the website associated with the sponsored entity. The marketing content module 220 may therefore generate a script for insertion on the sponsored entity's website, such that when the website is accessed, the marketing content of the sponsoring entity is displayed. The ad, when selected by a user, may redirect the user to a website of the sponsoring entity. As described above with respect to FIG. 5, the marketing facilitation system 130, may, in some embodiments, host the sponsored entity's website. In some embodiments, the marketing content module 220 and/or processor 200 may direct the communications module 204 to transmit the sponsoring entity's marketing content information to a third party host of the sponsored entity's website for display.

As shown by operation 928, the marketing facilitation system 130, such as with the communications module 204, processor 200, marketing content module 220, campaign management module 230, and/or the like, may be configured for causing transmittal of a request to a provider of the third party advertisement to provide the third party advertisement. As an example, the marketing content module 220 may direct the communications module 204 to transmit advertising information to the third party advertising system 100, regarding the sponsored entity's ads. The third party advertising system 100 may be a web-based search engine, and the request may therefore include targeted key words, which, when searched by a user of the third party advertising system 100, may result in display of the ad, which may direct the user to the sponsored entity's website. In some embodiments, the sponsored entity may be registered with the third party advertising system 100 such that the targeted key words, ad, URL and/or other information is already accessible to the third party advertising system 100. The request may further include a campaign budget, which may indicate a maximum dollar amount to spend on the campaign over a period of time. Such a request may be transmitted from the marketing facilitation system 130 to the third party advertising system 100 via a routine batch cycle, for example. In this regard, a request may comprise third party advertisement information relating to a plurality of campaigns and/or sponsored entities.

As shown by operation 932, the marketing facilitation system 130, such as with the communications module 204, processor 200, analytics module 250, and/or the like, may be configured for causing display of analytics data including at least one of a number of impressions or number of clicks of the third party advertisement occurring within a defined period of time. The third party advertising system 100 may therefore provide information to the marketing facilitation system 130 regarding the number of impressions (the number of times a third party advertisement is displayed) and clicks (the number of times a third party advertisement is selected) for campaigns facilitated by the marketing facilitation system 130. The marketing facilitation system 130 may provide the information to the sponsoring entity via a display such as the display of FIG. 8. The sponsoring entity may therefore use the analytics data to analyze the success of various campaigns.

FIG. 10 is a flowchart illustrating operations for facilitating business marketing relationships. The operations of FIG. 10 may be performed by marketing facilitation system 130, such as with the complimentary business module 240, processor 200, memory 202, communications module 204, input/output module 206, business entity database 210, and/or the like.

As shown by operation 1000, the marketing facilitation system 130, such as with the communications module 204, processor 200, analytics module 250, and/or the like, may be configured for identifying a service category and a defined geographic area of a subject business entity. The marketing facilitation system 130 may store such information in business entity database 210, for example. The service category may be provided during a registration process, for example, or provided by a third party information source. In some embodiments, a service category may be inferred from a business name, or the like. A defined geographic area may be identified in a similar manner, such as being provided by the business itself such as in a business profile, or derived from an address such as may be retrieved from a third party information source.

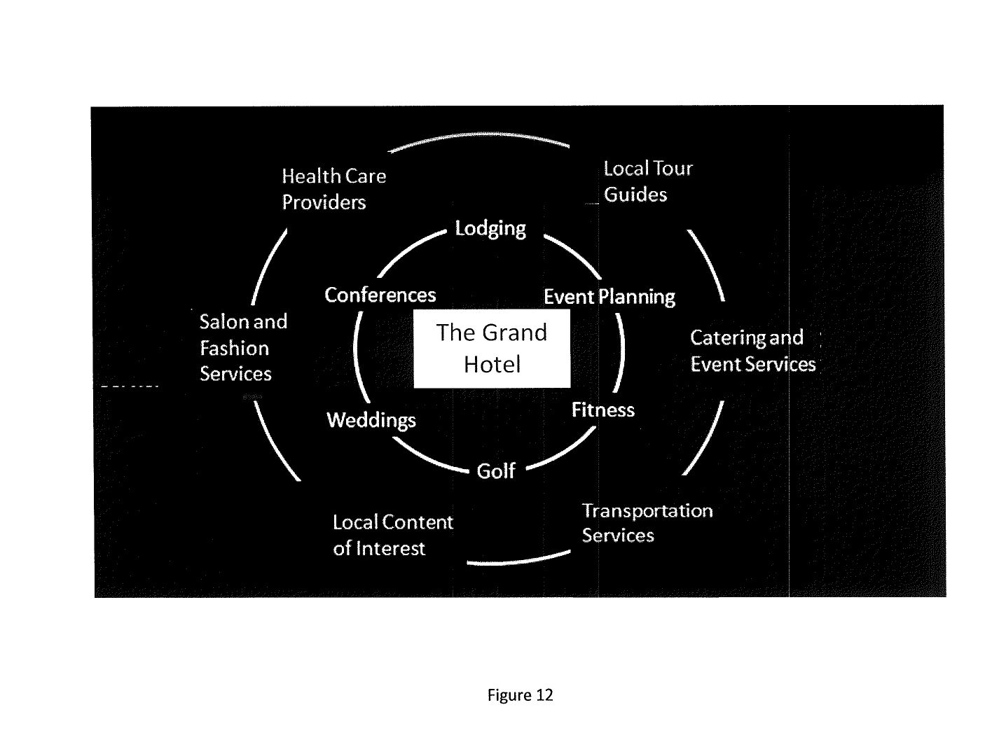

As shown by operation 1010, the marketing facilitation system 130, such as with the communications module 204, processor 200, business entity database 210, complimentary business module 240, and/or the like, may be configured for identifying at least one related service category to the subject category of the subject business entity. The complimentary business module 240, for example, may generate, maintain, or otherwise reference a model or hierarchy as illustrated in FIG. 12. The complimentary business module 240 may therefore identify related service categories. For example, visitors may utilize a hotel for lodging, conferences, weddings, golf, fitness, and/or event planning. Other types of businesses may be related to those. As such, various types of businesses may belong to related service categories.

As shown by operation 1020, the marketing facilitation system 130, such as with the communications module 204, processor 200, business entity database 210, complimentary business module 240, and/or the like, may be configured for identifying at least one related business entity belonging to the at least one related service category and located in the defined geographic area. As such, the complimentary business module 240 may search for other businesses in the business entity database 210.

As shown by operation 1030, the marketing facilitation system 130, such as with the communications module 204, processor 200, campaign management module 230, and/or the like, may be configured for receiving a request from the sponsored entity to block marketing content of a particular entity from being placed on the website associated with the sponsored entity. In this regard, although a sponsored entity may be registered with the marketing facilitation system 130 to enter into co-marketing campaigns sponsored by other businesses, the sponsored entity may wish to prevent such interlocks with particular sponsoring entities, for a variety of reasons relating to relationships with competitors of the sponsoring entities, for example. The marketing facilitation system 130 may therefore be configured, such as with the business entity database 210, to track such block requests. The campaign management module 230 may therefore prevent a sponsoring entity that is blocked by a sponsored entity from initiating a campaign. In some embodiments, the sponsored entity may not appear on any display provided by the marketing facilitation system 130 when accessed by the sponsoring entity.

As shown by operation 1040, the marketing facilitation system 130, such as with the communications module 204, processor 200, business entity database 210, complimentary business module 240, and/or the like, may be configured for establishing a marketing relationship between the subject business entity and the at least one related business entity in a business entity database, such as business entity database 210. The marketing relationship may result in a display of marketing content on a business entity's website, such as the complimentary business ads shown in area 520 of FIG. 5. In some embodiments, the marketing facilitation system 130 may provide a display, such as that of FIG. 5A, by which to search for and return related and/or complementary businesses, and to enable a user to recommend a particular business.

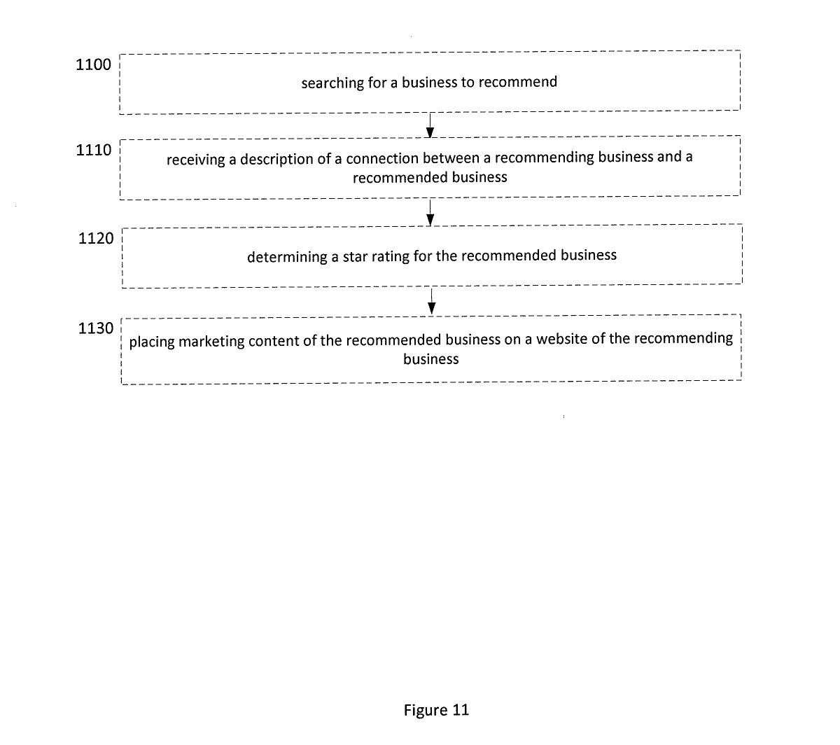

FIG. 11 is a flowchart illustrating operations for recommending businesses in accordance with some example embodiments discussed herein. As shown by operation 1100, the marketing facilitation system 130, such as with the communications module 204, processor 200, business entity database 210, and/or the like, may be configured for searching for a business to recommend. As described with respect to FIG. 5A, a user, such as a business user affiliated with a sponsored entity, for example, may search for other businesses, such as a small business providing a related service. A business user may select a business of the returned results, and provide a description of the business connection between the two businesses. As such, as shown by operation 1110, the marketing facilitation system 130, such as with the communications module 204, may be configured for receiving a description of a connection between a recommending business and a recommended business. The description of the connection or relationship may be stored on business entity database 210, for example, and may be viewed by other users using the marketing facilitation system 130 to develop connections or co-marketing relationships.

As shown by operation 1120, the marketing facilitation system 130, such as with the communications module 204, processor 200, business entity database 210, and/or the like, may be configured for determining a star rating for the recommended business. The star rating for a recommended business may be based on a number of recommending businesses of the recommend business, a number of co-marketing relationships the recommended business is engaged in, and/or the like. The star rating may be associated with a business in the business entity database 210, for example, and displayed with any description of the business by the marketing facilitation system 130, such as in FIG. 3 and FIG. 5B. In some embodiments, the result of such a recommendation may be that the recommended business is placed in rank order in the complementary businesses section of a recommending business's website, with a star signifying the recommendation.

As shown by operation 1130, the marketing facilitation system 130, such as with the communications module 204, processor 200, marketing content module 220, and/or the like, may be configured for placing marketing content of the recommended business on a website of the recommending business. As described herein, the marketing facilitation system 130 may provide marketing content space on a website of a business. In some embodiments, the marketing content space on a recommending business's website may be populated with marketing content of a recommended business, such as the marketing content of complementary businesses in area 520 of FIG. 5A.

In some embodiments, the recommending business and a recommended business may be sponsored entities (e.g., sponsored by the same and/or different sponsoring entities), and the recommendations may lead to increased traffic between the recommending business and recommended business websites and/or fuel additional sponsorship of the recommended/recommending businesses and expansion of co-marketing relationships. A business's marketing network may be therefore be expanded by the use of a recommendation service provided by the marketing facilitation system 130. The recommendations may facilitate a crowd sourcing of marketing efforts. Any trust engendered in a recommending business may pass to a recommended business, and a consumer can look at the offerings of a recommended and/or recommending business as a larger combined value statement.

FIG. 12 is a conceptual model of related service categories that may be generated, maintained, or otherwise referenced by marketing facilitation system 130, such as with the business entity database 210, and/or the like. A conceptual model may be used by marketing facilitation system 130 to facilitate business marketing relationships and marketing interlock campaigns as described herein. Various businesses may benefit from the functionalities described herein by maximizing marketing exposure and participating in peer-to-peer marketing integration. Networks comprising related businesses ranging from large corporate chains to small local businesses may be established to facilitate marketing efforts.

As will be appreciated, any of the above described operations, computer program instructions and/or other type of code may be loaded onto a computer, processor or other programmable apparatus circuitry to produce a machine, such that the computer, processor, or other programmable circuitry that executes the code on the machine creates the means for implementing various functions, including those described herein.

It is also noted that all or some of the information presented by the example displays discussed herein can be based on data that is received, generated and/or maintained by one or more components of marketing facilitation system 130. In some embodiments, one or more external systems (such as a remote cloud computing and/or data storage system) may also be leveraged to provide at least some of the functionality discussed herein.

As described above, and as will be appreciated based on this disclosure, embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

Embodiments of the present invention have been described above with reference to block diagrams and flowchart illustrations of methods, apparatuses, systems and computer program products. It will be understood that each block of the circuit diagrams and process flowcharts, and combinations of blocks in the circuit diagrams and process flowcharts, respectively, can be implemented by various means including computer program instructions. These computer program instructions may be loaded onto a general purpose computer, special purpose computer, or other programmable data processing apparatus, such as processor 200, marketing content module 220, campaign management module 230, complimentary business module 240, and/or analytics module 250 discussed above with reference to FIG. 2, to produce a machine, such that the computer program product includes the instructions which execute on the computer or other programmable data processing apparatus create a means for implementing the functions specified in the flowchart blocks.

These computer program instructions may also be stored in a computer-readable storage medium (e.g., memory 202) that can direct a computer or other programmable data processing apparatus to function in a particular manner, such that the instructions stored in the computer-readable storage medium produce an article of manufacture including computer-readable instructions for implementing the function discussed herein. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions discussed herein.

Accordingly, blocks of the block diagrams and flowchart illustrations support combinations of means for performing the specified functions, combinations of steps for performing the specified functions and program instruction means for performing the specified functions. It will also be understood that each block of the circuit diagrams and process flowcharts, and combinations of blocks in the circuit diagrams and process flowcharts, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for facilitating marketing of at least two entities, the method comprising:
receiving, from a sponsoring entity, a funding indication indicating an intent to fund a third party advertisement of a sponsored entity;
receiving, from the sponsored entity, a marketing indication indicating an intent to place marketing content of the sponsoring entity on a website associated with the sponsored entity in exchange for the sponsoring entity funding the third party advertisement of the sponsored entity; and
with a processor, and in response to the funding indication and marketing indication, causing the marketing content of the sponsoring entity to be displayed on the website associated with the sponsored entity.

2. The method of claim 1, further comprising:
providing to the sponsoring entity a plurality of entities within a predefined geographic proximity, wherein receiving the funding indication comprises receiving a selection of at least one of the plurality of entities as the sponsored entity.

3. The method of claim 1, further comprising:
based on the funding indication, transmitting a request to the sponsored entity expressing the intent of the sponsoring entity to fund the third party advertisement of the sponsored entity.

4. The method of claim 1, wherein the third party advertisement of the sponsored entity comprises a link to the website associated with the sponsored entity.

5. The method of claim 5, wherein the third party advertisement of the sponsored entity is provided via a web-based search engine.

6. The method of claim 1, wherein the marketing content comprises a link to a website associated with the sponsoring entity.

7. The method of claim 1, wherein receiving the marketing indication comprises receiving an indication of an agreement between the sponsored entity and a marketing facilitator to reserve marketing content space on the website associated with the sponsored entity, wherein the agreement is made prior to receiving the funding indication, and the method further comprises maintaining the marketing content space on the website associated with the sponsored entity.

8. The method of claim 1, further comprising:
causing transmittal of a notification to a provider of the third party advertisement to provide the third party advertisement of the sponsored entity.

9. The method of claim 1, wherein the sponsored entity is not initially registered with a marketing facilitator and the funding indication comprises information identifying the sponsored entity, and the method further comprises:
in response to the funding indication, causing transmittal, to the sponsored entity, of an invitation to register with the marketing facilitator.

10. The method of claim 1, further comprising:
receiving a recommendation from the sponsored entity to recommend a recommended business; and
in response to the recommendation, causing display of marketing content of the recommended business on the website associated with the sponsored entity.

11. The method of claim 1, further comprising:
causing display of analytics data including at least one of a number of impressions or number of clicks of the third party advertisement occurring within a defined period of time.

12. A computer program product for facilitating marketing of at least two entities, the computer program product comprising at least one non-transitory computer-readable medium having computer-readable program instructions stored therein, the computer-readable program instructions comprising instructions, which, when performed by an apparatus, are configured to cause the apparatus to at least:
receive, from a sponsoring entity, a funding indication indicating an intent to fund a third party advertisement of a sponsored entity;
receive, from the sponsored entity, a marketing indication indicating an intent to place marketing content of the sponsoring entity on a website associated with the sponsored entity in exchange for the sponsoring entity funding the third party advertisement of the sponsored entity; and
in response to the funding indication and marketing indication, cause the marketing content of the sponsoring entity to be displayed on the website associated with the sponsored entity.

13. The computer program product of claim 12, wherein the computer-readable program instructions further comprise instructions, which, when performed by an apparatus, are configured to cause the apparatus to at least:
provide to the sponsoring entity a plurality of entities within a predefined geographic proximity, wherein receiving the funding indication comprises receiving a selection of at least one of the plurality of entities as the sponsored entity.

14. The computer program product of claim 12, wherein the computer-readable program instructions further comprise instructions, which, when performed by an apparatus, are configured to cause the apparatus to at least:
based on the funding indication, transmit a notification to the sponsored entity expressing the intent of the sponsoring entity to fund the third party advertisement of the sponsored entity.

15. The computer program product of claim 12, wherein receiving the marketing indication comprises receiving an indication of an agreement between the sponsored entity and a marketing facilitator to reserve marketing content space on the website associated with the sponsored entity, wherein the agreement is made prior to receiving the funding indication, and the computer-readable program instructions further comprise instructions, which, when performed by an apparatus, are configured to cause the apparatus to at least:
maintain the marketing content space on the website associated with the sponsored entity.

16. The computer program product of claim 12, wherein the computer-readable program instructions further comprise instructions, which, when performed by an apparatus, are configured to cause the apparatus to at least:
cause transmittal of a request to a provider of the third party advertisement to provide the third party advertisement of the sponsored entity.

17. The computer program product of claim 12, wherein the sponsored entity is not initially registered with a marketing facilitator and the funding indication comprises information identifying the sponsored entity, and the computer-readable program instructions further comprise instructions, which, when performed by an apparatus, are configured to cause the apparatus to at least:
in response to the funding indication, cause transmittal, to the sponsored entity, of an invitation to register with the marketing facilitator.

18. The computer program product of claim 12, wherein the computer-readable program instructions further comprise instructions, which, when performed by an apparatus, are configured to cause the apparatus to at least:
receive a request from the sponsored entity block marketing content of a particular entity from being placed on the website associated with the sponsored entity.

19. The computer program product of claim 12, wherein the computer-readable program instructions further comprise instructions, which, when performed by an apparatus, are configured to cause the apparatus to at least:
cause display of analytics data including at least one of a number of impressions or number of clicks of the third party advertisement occurring within a defined period of time.

20. A method for facilitating business marketing relationships comprising:
identifying a service category and a defined geographic area of a subject business entity;
identifying at least one related service category to the subject category of the subject business entity;
identifying at least one related business entity belonging to the at least one related service category and located in the defined geographic area; and
establishing a marketing relationship between the subject business entity and the at least one related business entity in a business entity database.
